(19) United States
(12) Patent Application Publication
(10) Pub. No.: US 2006/0039522 A1
(43) Pub. Date: Feb. 23, 2006

(54) Cyclotron target, apparatus for handling fluids with respect thereto and for recovering irradiated fluids, and methods of operating same

(75) Inventors: Erol Bars, Grand Island, NY (US); Lynn M. Kaczmarek, East Aurora, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Research Foundation of the State University of New York

(21) Appl. No.: 11/151,038

(22) Filed: Jun. 13, 2005

Related U.S. Application Data
(60) Provisional application No. 60/602,431, filed on Aug. 18, 2004.

(51) Int. Cl. G21G 1/06

(52) U.S. Cl. 376/166

(57) ABSTRACT

A target (81) for a cyclotron has a chamber (85) provided with a substantially frusto-conical side wall (84) and an arcuate concave bottom surface (86). The bottom is so dimensioned, configured and arranged that scattered protons will fall incident upon the bottom surface substantially right angles with respect thereto. One apparatus (20) also automatically loads and unloads the target chamber with fluid, and another apparatus (91) recovers collected isotopes after radiation.

### CROSS-REFERENCE TO RELATED APPLICATION

This application claims domestic priority on earlier-filed U.S. Pat. Application No. 60/602,431, filed on Aug. 18, 2004.

### TECHNICAL FIELD

The present invention relates generally to cyclotrons, and, more particularly, to: (1) an improved target for use with a cyclotron that is particularly adapted to produce F¹⁸ and/or N¹³ isotopes ammonia by bombarding a fluid (e.g., O¹⁸ or O¹⁶) with a proton beam; (2) apparatus for selectively loading and unloading a target chamber with an irradiable fluid in a cyclotron vault according to pre-programmed sequences; (3) a method of controlling the flows of irradiable fluid in a network between a source of irradiable fluid, a target chamber arranged in a cyclotron vault, and an outlet; and (4) apparatus for recovering irradiated fluids from one or more target chambers within a cyclotron vault.

### BACKGROUND ART

It is sometimes desired to produce radioactive isotopes having short half-lives. One of these is fluorine-18 (“F¹⁸”). This is commonly used in Positron Emission Tomography (“PET”) scans and the like. F¹⁸ has a half-life of approximately 110 minutes. Additional details on this isotope, as well as its use in PET scans may be found in http://encyclopedia.thefreedictionary.com/(18F)fluorodeoxyglucose.htm and http://www. fda.gov/cder/regulatory/pet/fdgfinal.htm, the aggregate disclosures of which are hereby incorporated by reference.

While the process of using a cyclotron to bombard enriched water (O¹⁸) with a beam of protons (H⁺) so as to produce F¹⁸ is well-known, in some existing targets, a quantity of water that has been bombarded in the target chamber is retained in the chamber. This reduces the production yield of the transmuted isotope.

At the same time, it is felt that the yield of the isotope can be increased by automating the manner by which the target chamber is loaded with irradiable fluid, and by automating the manner by which irradiated fluid is unloaded from the chamber. In this regard, it must be remembered that the irradiated fluid contains a radioactive isotope, and that safeguards must be taken to prevent human exposure to same. There is a further need to isolate or concentrate the isotope from the irradiated fluid.

Accordingly, it would be generally desirable to provide an improved target for use with a cyclotron that would offer increased yields of the F¹⁸ and N¹³ isotopes being produced.

It would also be desirable to automate the process for selectively loading and unloading a target chamber with irradiable fluid within a cyclotron vault, and for selectively unloading irradiated fluid from the chamber.

It would also be desirable to provide an improved method of controlling the flow of irradiable fluid in a network between a source of irradiable fluid, a target chamber arranged in a cyclotron vault, and an outlet.

It would also be desirable to provide improved apparatus for recovering irradiated fluids from one or more target chambers within a cyclotron vault

### DISCLOSURE OF THE INVENTION

With parenthetical reference to the corresponding parts, portions or surfaces of the disclosed embodiment, merely for purposes of illustration and not by way of limitation, the present invention broadly provides: (1) an improved target for a cyclotron; (2) an apparatus for selectively loading and unloading a target chamber with an irradiable fluid according to pre-programmed sequences; (3) an improved method of controlling the flow of irradiable fluid in a network; and (4) apparatus for recovering irradiated fluids from a plurality of target chambers within a cyclotron vault.

In one aspect, the invention provides an improved target (81) for a cyclotron that produces an isotope, comprising: a block of material (82) having a face (83); and a chamber (85) extending into the block from the face, the chamber having a substantially frusto-conical side wall (84) and a concave bottom surface (86), the side wall being arranged substantially parallel to scattered proton beams projected into the chamber from the cyclotron, the bottom surface being so dimensioned, configured and arranged that a majority of the scattered proton beams will fall incident upon the bottom surface substantially at right angles with respect thereto such that fluid will not be retained in the chamber when the chamber is drained.

The material may be silver, aluminum or niobium. The compound may be F¹⁸. The isotope may be nitrogen-13 (“N^{13”}). The target may further include an inlet (90) for selectively admitting fluid from a source to the chamber, and an outlet (90) for selectively draining fluid from the chamber. The majority of scattered proton beams may fall incident on the bottom surface an angle of 90°±15°.

In another aspect, the invention provides apparatus (20) for selectively loading and unloading a target chamber with an irradiable fluid in a cyclotron vault (21), comprising: a first conduit (25) communicating the chamber with a vent; a first solenoid valve (V1) in the first conduit; a second conduit (26) communicating with the chamber; a second solenoid valve (V2) in the second conduit; a third conduit (28) communicating the chamber with an outlet; a third solenoid valve (V3) in the third conduit; an irradiable fluid source (30); a fourth conduit (29) communicating the chamber with the irradiable fluid source; a fourth solenoid valve (V4) in the fourth conduit; a fifth solenoid valve (V5) in the fourth conduit; a source (32) of pressurized fluid (He); a fifth conduit (31) communicating the pressurized fluid source with the irradiable fluid source; an electrically-operated two-way sixth valve (V6) in the fifth conduit; and wherein the second conduit communicates with the sixth valve.

The first solenoid valve (V1), the second solenoid valve (V2), the third solenoid valve (V3) and the fourth solenoid valve (V4) may be located within the cyclotron vault (21). The apparatus may further include a pressure sensor (33) operatively arranged to monitor the pressure in the chamber. This pressure sensor may be located within the cyclotron vault. The irradiable fluid source (30), the pressurized fluid source (32), the fifth solenoid valve (V5) and the sixth solenoid valve (V6) maybe located outside of the cyclotron vault.

The irradiable fluid may be selected from the group consisting of O¹⁸ and O¹⁶. The pressurized fluid may be selected from the group consisting of argon and helium.

The apparatus may further include a controller (23) for controlling the operation of the valves so as to test the fluid-tight sealed integrity of the valves and conduits with the pressurized fluid. This controller may be located outside of the cyclotron vault. The valves may be operated in one sequence to selectively load the chamber with the irradiable fluid from the source thereof, and operated in another sequence to selectively move irradiable fluid from the chamber to the outlet.

In another aspect, the invention provides an improved method of controlling the flow of irradiable fluid in a network between a source (30) of irradiable fluid, a target chamber (24) arranged in a cyclotron vault, and an outlet (28), comprising the steps of: testing the fluid-tight sealed integrity of the network; providing the source of irradiable fluid outside the cyclotron vault; causing irradiable fluid to flow from the source thereof into the target chamber; and causing irradiable fluid in the chamber to flow outside the vault to the outlet.

The step of testing the fluid-tight sealed integrity of the network may include the steps of: providing a source of pressurized fluid; charging the network with pressurized fluid from the source; and monitoring the pressure of fluid in such charged network for a period of time. The method may include the additional step of indicating a failure of the fluid-tight sealed integrity of the network if the pressure falls by more than a predetermined amount in the period of time. These various steps are preferably performed automatically.

In still another aspect, the invention provides improved apparatus (91) for recovering irradiated fluids from a plurality of target chambers within a cyclotron vault, comprising: a first valve (92) having an outlet and having a plurality of inlets, a number of the inlets communicating with a corresponding number of the targets, the first valve being operable to selectively communicate any of the inlets with the outlet; a second valve (94) having an inlet communicating with the first valve outlet, and having a plurality of outlets, the second valve being selectively operable to communicate the second valve inlet with any of the second valve outlets; a plurality of cartridges, each cartridge having an inlet communicating with a respective one of the second valve outlets and having an outlet, each of the cartridges being adapted to remove an irradiate ion from an irradiated fluid by an ion exchange process; and a third valve (96) having an inlet communicating with each of the cartridge outlets and having at least one outlet, the third valve being selectively operable to enable fluid flow from the third valve inlet to the third valve outlet.

The first valve may have one of its inlets communicating with one of the target chambers, and may have another of its inlets communicating with a source of a first fluid for flushing a first irradiated ion from its associated cartridge. The first valve may have another of its inlets communicating with another of the target chambers, and may have another of its inlets communicating with a source of a second fluid for flushing a second irradiated ion from its associated cartridge. The third valve may have another of its inlets communicating with a recovery container. The apparatus may further include: a conduit leading from the third valve outlet; a filter operatively arranged in the conduit; and a collection vial communicating with the conduit.

Accordingly, the general object of the invention is to provide an improved target for a cyclotron that produces an isotope.

Another object is to provide improved apparatus for selectively loading an unloading a target chamber with an irradiable fluid in a cyclotron vault.

Another object is to provide an improved method of controlling the flow of irradiable fluid in a network between a source of irradiable fluid, a target chamber arranged in a cyclotron vault, and an outlet.

Another object is to provide for the recovery of irradiated fluids in an aseptic environment.

Another object is to provide improved apparatus for recovering and/or processing irradiated fluids from a plurality of target chambers within a cyclotron vault.

Still another object is to provide improved apparatus for recovering and/or processing irradiated fluids from a plurality of target chambers within a cyclotron vault, and which allows the user the ability to quickly and easily modify several functions.

These and other objects and advantages will become apparent from the foregoing and ongoing written specification, the drawings and the appended claims.

### BRIEF DESCRIPTION OF THE DRAWINGS

FIG. 1 a schematic view of improved apparatus for selectively loading and unloading a target chamber with an irradiable fluid in a cyclotron vault.

FIG. 2 is schematic view, partly in section and partly schematic, of one form of a conventional cyclotron target for use in F¹⁸ and N¹³ isotope production.

FIG. 3 is a view similar to FIG. 2, of the improved cyclotron target, this view showing the chamber as generally resembling the shape of the Apollo spacecraft.

FIG. 4 is a flow chart showing the sequence in loading the target chamber.

FIG. 5 is a flow chart showing the sequence in unloading the target chamber.

FIG. 6 is a schematic view of a first form of apparatus for recovering irradiated fluids from a plurality of target chambers within a cyclotron vault.

FIG. 7 is a schematic view of a second form of apparatus for recovering an irradiated fluid from a single target chamber within a cyclotron vault.

### DESCRIPTION OF THE PREFERRED EMBODIMENT

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Apparatus for Loading and Unloading a Target Chamber

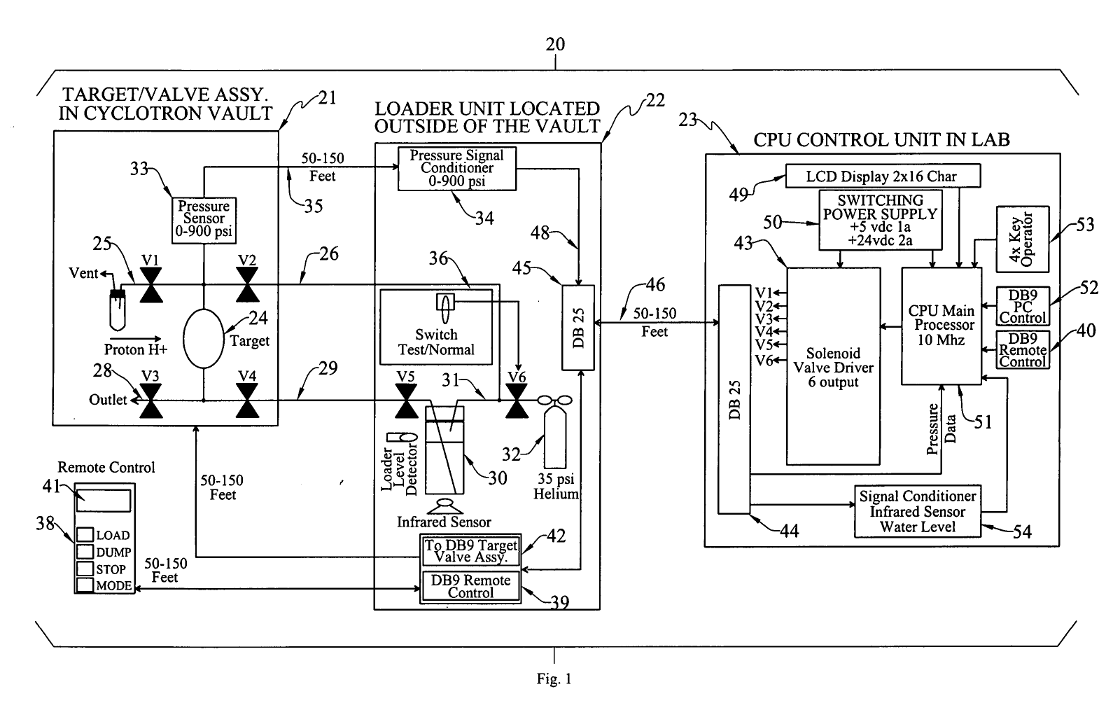

Referring now to the drawings, and, more particularly, to FIG. 1 thereof, the present invention broadly provides improved apparatus, generally indicated at 20, for selectively, and preferably automatically, loading a target chamber with irradiable fluid according to a predetermined loading sequence, and for selectively unloading the target chamber with irradiated fluid according to a predetermined unloading sequence.

The improved apparatus has one portion which is arranged within a cyclotron vault, generally indicated at 21; another portion, generally indicated at 22, that is arranged outside of the cyclotron vault; and a controller, generally indicated at 23, also located outside the cyclotron vault.

Within the vault is located a target 24 having a chamber (not shown in FIG. 1). Four electrically-operated normally-closed solenoid valves, indicated at V1, V2, V3 and V4, respectively, are operatively arranged within vault 21 to control the flows of fluid with respect to the target chamber. Valve V1 is arranged in a first conduit 25 that communicates the target chamber with a vent. Valve V2 is located in a second conduit 26. Valve V3 is arranged in a third conduit 28 that communicates the target chamber with the outlet. Valve V4 is arranged in a fourth conduit 29 that communicates the target chamber with a source of irradiable fluid, the source being generally indicated at 30. Valve V5 is also arranged in fourth conduit 29. Valve V6 is arranged in a fifth conduit 31 that, which communicates the source 30 of irradiable fluid with a pressurizing source, such as a tank 32 of pressurized helium or some other inert gas. A pressure sensor 33 is arranged to monitor the pressure within the target chamber, and is arranged to provide an electrical signal, reflecting such sensed pressure, to a signal conditioner 34 via conductor 35.

Second conduit 26 communicates with the fifth conduit between source 30 and valve V6. A test/normal switch 36 is arranged to control the operation of valve V6.

A remote control unit 38 is arranged outside of the cyclotron vault, and is arranged to be connected to a DB9 remote control unit 39 located in the loader unit 22 outside of the vault. This remote control unit may be uncoupled from unit 39, and be alternatively connected to DB9 remote control unit 40 in the controller, if desired. Remote control unit 38 has a visual display 41, and a series of buttons associated with the “load”, “dump”, “stop” and manual/automatic “mode” features. Electrical control of all valves is effected by a DB9 target valve assembly 42, which is controlled by a solenoid valve driver 43 within the controller. This valve driver produces 6 outputs, labeled V1-V6, respectively, which are supplied to the correspondingly-identified valves. These outputs are provided to a terminal block 44, which communicates with another terminal block 45 within the Loader Unit 22 via a conductor 46. Terminal block 45 is arranged to exchange signals, as may be necessary, with DB9 target valve assembly 42 and DB9 remote control unit 39. The conditioned pressure signal is provided via line 48 to terminal block 45.

In the transmutation of F¹⁸, the source 30 is filled with liquid O¹⁸. The level of O¹⁸ within source 30 is determined and monitored by a loader liquid level detector and an infrared sensor, each so labeled in FIG. 1. Tank 32 supplies pressurized helium to the space above the liquid in source 30 so as to pressurize the source. The fluid within chamber 30 maybe either a liquid or a gas, depending on the nature of the transmutation reaction set forth. In one operation, heavy water, O¹⁸, is transmuted to F¹⁸. In another reaction, O¹⁶ is transmuted to N¹³. In still another reaction, O¹⁶ is converted to O¹⁵. These reactions occur when fluid provided by source 30 is supplied to the chamber in target 24 and the target is irradiated with a beam of protons (H⁺) from the cyclotron.

Still referring principally to FIG. 1, the controller 23 is shown as having an LCD display 49, a switching power supply 50, solenoid valve driver 43, terminal block 44, a main central processing unit (“CPU”) 51 operating at 10 Mhz, a DB9 PC control unit 52, and a four-button key-pad operator 53. Information concerning the signal conditioner, the infrared sensor and the water level is provided from the loader unit through terminal block 44 and block 54 to CPU 51. CPU 51 then controls the operational sequence of the valves.

Loading Sequence

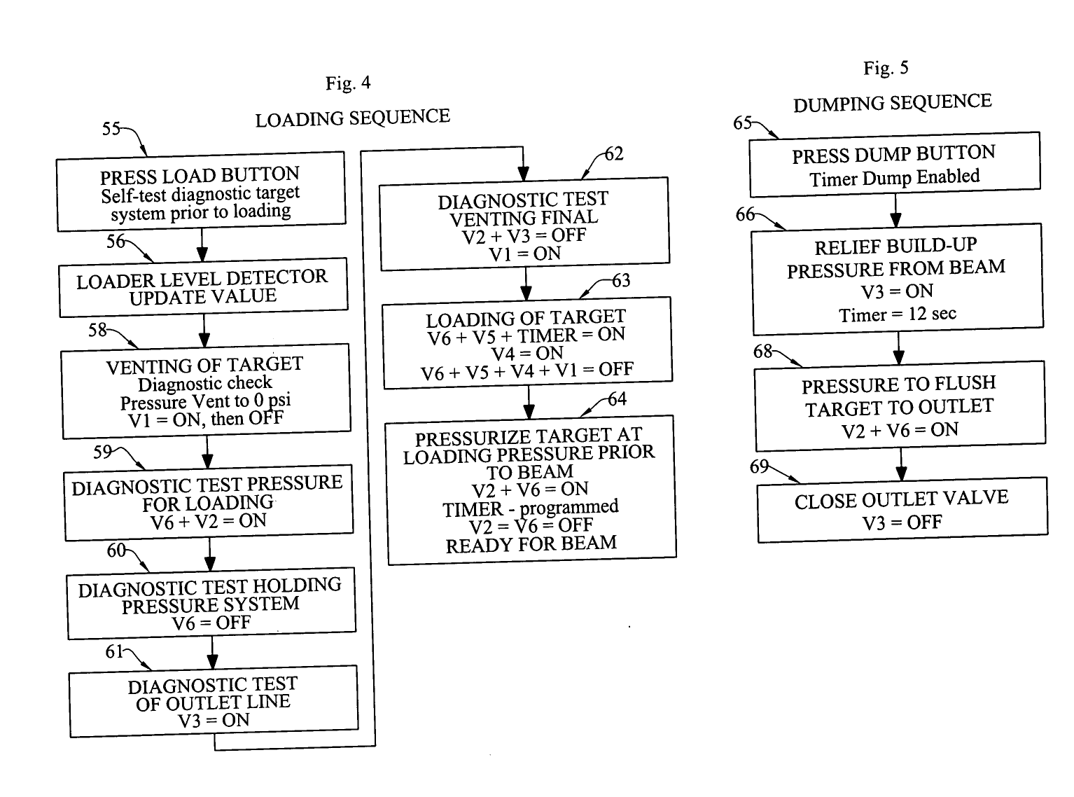

The loading sequence is illustrated in FIG. 4.

The operator initially presses the “load” button on remote controller 38 to initiate a self-test diagnostic of the fluid network prior to loading, this being indicated by box 55.

When so initiated, the loader level detector updates the value reflecting the level of liquid in source 30, as indicated by box 56.

The next step is to vent the target. V1 is turned “on” to permit any pressurized fluid in the target chamber to be vented. Then V1 is turned “off”. This is indicated in box 58.

The next step is to pressurize the target chamber with helium from source 32, as indicated in box 59. To do this, valves V6 and V2 are turned “on” (i.e., opened) to charge the target chamber with pressure from source 32.

Thereafter, the test pressure is held for a predetermined period of time. Valve V6 is turned “off”, and the system is tested for the predetermined time period to determine whether there is any decay or leakage of the test pressure. This is determined by pressure sensor 33. This test pressure hold feature is represented by box 60.

Thereafter, valve V3 is turned “on” (i.e., opened) to vent the test pressure to the outlet, as indicated in box 61.

Valves V2 and V3 are then turned “off”, and valve V1 is then opened to vent any remaining pressure, as indicated by box 62.

Thereafter, the target is loaded with irradiable fluid from the source, as indicated in box 63. To do this, valves V6 and V5 are opened. When valve V6 is opened, the space above the liquid in source 30 is pressurized. Hence, pressurized fluid may flow from the source. Valve V4 is opened to admit irradiable fluid to the target chamber. Thereafter, valves V6, V5, V4 and V1 are turned off.

Finally, as indicated in box 64, the irradiable fluid within the chamber is pressurized prior to being irradiated. To do this, valves V2 and V6 are turned “on” for a predetermined period of time. This admits pressurized helium from source 32 to the target chamber. Thereafter, valves V2 and V6 are turned “off”, and the target is now ready to be irradiated.

As indicated above, the cyclotron will selectively generate a beam of protons (H⁺) which are directed at the target. When the fluid in the target chamber is irradiated with the beam of protons, O¹⁸ is transmuted to F¹⁸, O¹⁶ is transmuted to N^{13,} or O¹⁶ is transmitted to O¹⁵, depending on the nature of the irradiable fluid.

After the fluid in the target chamber has been irradiated, it is necessary to unload or dump the fluid to the outlet. This sequence is shown in FIG. 5.

Unloading Sequence

As indicated in box 65, the operator then presses the “dump” button, either on remote control unit 38 or on the CPU. This initiates the unloading sequence.

As indicated in box 66, valve V3 is then turned “on” for a period of twelve seconds, this allows pressurized fluid to flow from the target chamber to the outlet. Thereafter, as indicated in box 68, valves V2 and V6 are turned “on” to flush irradiated fluid from the target chamber with pressurized helium. Thereafter, valve V3 is turned “off”, as indicated in box 69.

Improved Cyclotron Target

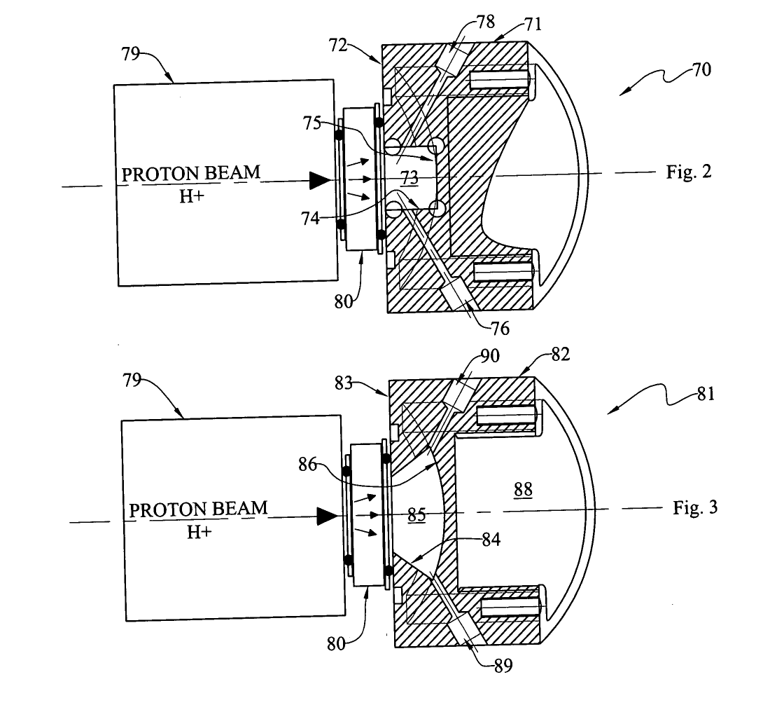

Referring now to FIG. 2, a conventional target for use with the cyclotron in the production of F¹⁸ and N¹³ isotopes is generally indicated at 70. This target is shown as including a substantially-rectangular block 71 of material, such as silver or aluminum. The block has a leftward planar vertical face 72. A cylindrical chamber 73 extends rightwardly into the block from the center of left face 72. This chamber is bounded by a horizontal cylindrical side wall 74 and a leftwardly-facing planar circular bottom surface 75. An inlet 76 and an outlet 78 communicate with the chamber to selectively admit and drain fluid with respect thereto. A cyclotron 79 is arranged to emit a proton beam rightwardly through an aluminum filter 80 into the chamber. This causes scattering or dispersion of the proton beams in the chamber.

When it was desired to drain the chamber in the prior art device, it was found that fluid that had been subjected to the proton beams would be retained in the corners thereof, this being schematically indicated by the circles at the four corners of the chamber.

Referring now to FIG. 3, an improved target is generally indicated at 81. This improved target is again associated with a cyclotron 79 that selectively emits a proton beam and supplies it through a havar or aluminum filter 80. The improved target also has a block 82 of material, again either silver or aluminum. However, the salient difference lies in the shape of chamber 83. Whereas chamber 73 in the prior art embodiment was in the form of a cylinder extending rightwardly into the block from left end face 72, in the improved target, the chamber somewhat resembles the shape of the Apollo spacecraft. More particularly, the improved chamber 83 is bounded by an inwardly- and rightwardly-facing frusto-conical surface 84 extending into the block 82 from left end face 82, and a concave arcuate bottom surface 86. The side wall is so configured and arranged as to be substantially parallel to scattered proton beams projected into the chamber from the cyclotron through the filter. The bottom surface is so dimensioned, configured and arranged that scattered proton beams will fall incident upon the bottom surface substantially at right angles (i.e., 90°±15°) with respect thereto.

The shape of the water cooling recess 88 that extends rightwardly into the block from its left end face is not believed to be material. Moreover, the improved target again as a fluid inlet 89, and fluid outlet 90. Thus, in the well-known manner, enriched water (O¹⁸) may be admitted to the chamber in batch mode. The fluid in the chamber is then subjected to a proton beam (H⁺) to produce F¹⁸. It has been Applicants' experience that the shape of the chamber contributes substantially to an improved draining of the chamber. In other words, less fluid is retained in the chamber. In another application, the fluid is O¹⁶ and the block is formed of aluminum. Such fluid is admitted to the chamber, and is bombarded with protons to produce N¹³.

Apparatus for Recovering Irradiated Fluids

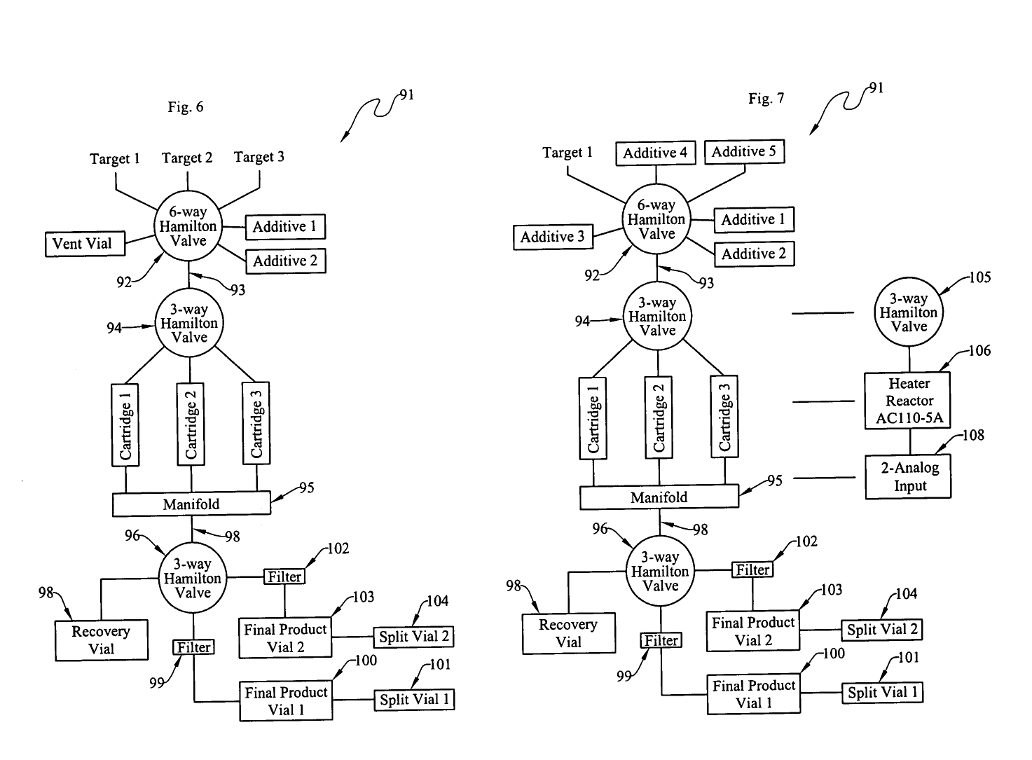

Referring now to FIG. 6, apparatus for recovering and/or processing irradiated fluids from multiple targets is generally indicated at 91. This apparatus includes a six-way rotary Hamilton valve 92 that is arranged to receive inputs from Target Chamber 1, Target Chamber 2 or Target Chamber 3, to vent fluids to a Vent Vial, or to receive Additive 1 or Additive 2. Any of these six inputs may pass through the six-way Hamilton valve to an outlet which communicates via a conduit 93 with a three-way rotary Hamilton valve 94. This valve has three outlets that communicate with three cartridges, labeled Cartridge 1, Cartridge 2 and Cartridge 3, respectively. The outputs from these three cartridges lead to a manifold 95 which communicates with another three-way rotary Hamilton valve 96 via conduit 98. The fluid flowing into Hamilton valve 96 may be directed either to a Recovery Vial 98, or via a filter 99 to Final Product Vial 100 which communicates with a Split Vial 101, or via filter 102 to another Final Product Vial 103, which also communicates with a split vial 104. Thus, the irradiated fluid from many of Target chambers 1, 2 or 3 may be selectively provided via the six-way Hamilton valve to outlet 93. Valve 94 may be selectively operated so as to direct the irradiated fluid to any of cartridges 1, 2 or 3. In the cartridge, the isotope is replaced by an ion exchange process.

The remaining fluid may be directed via valve 96 to a recovery vial.

To remove the isotope from the cartridges, Additives 1 and/or 2 are provided to valve 92. This has the effect of flushing the retained isotope from the associated cartridge. Thereafter, valve 96 may be operated so as direct the concentrated and flushed isotope via filter 99 to final product vial 100, or via filter 102 to final product vial 103. In either event, the fluid accumulating in the Final Product Vials may be apportioned between the split vials, as desired.

FIG. 7 is a view generally similar to FIG. 6. Hence, the same reference numeral has been used to identify the corresponding structure previously described. However, the salient difference is that valve 92 is arranged to be provided with Additive 1, Additive 2, Additive 3, Additive 4 or Additive 5. Valve 92 communicates with a single target chamber 1. The remaining structure is substantially as shown.

The dashed figure to the right indicates that valve 94 and the cartridges could alternatively be replaced with another three-way rotary Hamilton valve 105, which communicates via a heater reaction 106 with a two analog input 108.

Modifications

The present invention contemplates that many changes and modifications may be made. For example, the particular number and type of solenoid-operated valves in FIG. 1 may be changed. The remote control feature is optional. The apparatus may be controlled by the 4x key operator associated with the controller 23. Target 24 may be of the conventional or improved type. The pressurizing fluid may be helium or argon, or some other inert fluid. Other details of the overall system may be changed.

The apparatus shown in FIGS. 6 and 7 represents two extreme environments. The apparatus may be readily changed or modified within these two extremes.

Similarly, while the improved target is presently preferred, this too maybe changed. The loading and unloading sequence may also be changed, as may be the apparatus for recovering the collected radioactive isotopes.

Therefore, while the preferred form of the improved apparatuses has been shown and described, and several changes thereof discussed, persons skilled in this art will readily appreciate that various additional changes and modifications may be made without departing from the spirit of the invention, as defined and differentiated in the following claims.

What is claimed is:

1. A target for a cyclotron that produces an isotope, comprising:
a block of material having a face; and
a chamber extending into said block from said face, said chamber having a substantially frusto-conical side wall and a concave bottom surface, said side wall being arranged substantially parallel to scattered proton beams projected into said chamber from said cyclotron, said bottom surface being so dimensioned, configured and arranged that a majority of said scattered proton beams will fall incident upon said bottom surface substantially at right angles with respect thereto such that fluid will not be retained in said chamber when said chamber is drained.

2. A target as set forth in claim 1 wherein said material is aluminum, silver or niobium.

3. A target as set forth in claim 2 wherein said compound is F¹⁸.

4. A target as set forth in claim 1 wherein said material is aluminum.

5. A target as set forth in claim 1 wherein said isotope is N¹³.

6. A target as set forth in claim 1 and further comprising an inlet for selectively admitting fluid from a source to said chamber, and an outlet for selectively draining fluid from said chamber.

7. A target as set forth in claim 1 wherein said majority of scattered proton beams fall incident on said bottom surface an angle of 90°±15°.

8. Apparatus for selectively loading and unloading a target chamber with an irradiable fluid in a cyclotron vault, comprising:
a first conduit communicating said chamber with a vent;
a first solenoid valve (V1) in said first conduit;
a second conduit communicating with said chamber;
a second solenoid valve (V2) in said second conduit;
a third conduit communicating said chamber with an outlet;
a third solenoid valve (V3) in said third conduit;
an irradiable fluid source (O¹⁸);
a fourth conduit communicating said chamber with said irradiable fluid source;
a fourth solenoid valve (V4) in said fourth conduit;
a fifth solenoid valve (V5) in said fourth conduit;
a source of pressurized fluid (He);
a fifth conduit communicating said pressurized fluid source with said irradiable fluid source;
an electrically-operated two-way sixth valve (V6) in said fifth conduit; and
wherein said second conduit communicates with said sixth valve.

9. The apparatus as set forth in claim 8 wherein said first solenoid valve, said second solenoid valve, said third solenoid valve and said fourth solenoid valve are located within said cyclotron vault.

10. The apparatus as set forth in claim 8 and further comprising:
a pressure sensor operatively arranged to monitor the pressure in said chamber.

11. The apparatus as set forth in claim 10 wherein said pressure sensor is located within said cyclotron vault.

12. The apparatus as set forth in claim 8 wherein said irradiable fluid source, said pressurized fluid source, said fifth solenoid valve and said sixth solenoid valve are located outside of said cyclotron vault.

13. The apparatus as set forth in claim 8 wherein said irradiable fluid is selected from the group consisting of O¹⁸ and O¹⁶.

14. The apparatus as set forth in claim 8 wherein said pressurized fluid is selected from the group consisting of argon and helium.

15. The apparatus as set forth in claim 8 and further comprising a controller for controlling the operation of said valves so as to test the fluid-tight sealed integrity of said valves and conduits with said pressurized fluid.

16. The apparatus as set forth in claim 8 wherein said controller is located outside of said cyclotron vault.

17. The apparatus as set forth in claim 8 wherein said valves are operated in one sequence to selectively load said chamber with said irradiable fluid from the source thereof.

18. The apparatus as set forth in claim 17 wherein said valves are operated in another sequence to selectively move irradiable fluid from said chamber to said outlet.

19. The method of controlling the flow of irradiable fluid in a network between a source of irradiable fluid, a target chamber arranged in a cyclotron vault, and an outlet, comprising the steps of:
testing the fluid-tight sealed integrity of said network;
providing said source of irradiable fluid outside said cyclotron vault;
causing irradiable fluid to flow from the source thereof into said target chamber; and
causing irradiable fluid in said chamber to flow outside said vault to said outlet.

20. The method as set forth in claim 19 wherein the step of testing the fluid-tight sealed integrity of said network includes the steps of:
providing a source of pressurized fluid;
charging said network with pressurized fluid from said source; and
monitoring the pressure of fluid in such charged network for a period of time.

21. The method as set forth in claim 20 and further including the step of:
indicating a failure of the fluid-tight sealed integrity of said network if said pressure falls by more than a predetermined amount in said period of time.

22. The method as set forth in claim 19 wherein said steps are performed automatically.

23. The method as set forth in claim 20 wherein said steps are performed automatically.

24. The method as set forth in claim 21 wherein said step is performed automatically.

25. Apparatus for recovering irradiated fluids from a plurality of target chambers within a cyclotron vault, comprising:
a first valve having an outlet and having a plurality of inlets, a number of said inlets communicating with a corresponding number of said targets, said first valve being operable to selectively communicate any of said inlets with said outlet;
a second valve having an inlet communicating with said first valve outlet, and having a plurality of outlets, said second valve being selectively operable to communicate said second valve inlet with any of said second valve outlets;
a plurality of cartridges, each cartridge having an inlet communicating with a respective one of said second valve outlets and having an outlet, each of said cartridges being adapted to remove an irradiate ion from an irradiated fluid by an ion exchange process; and
a third valve having an inlet communicating with each of said cartridge outlets and having at least one outlet, said third valve being selectively operable to enable fluid flow from said third valve inlet to said third valve outlet.

26. The apparatus as set forth in claim 25 wherein said first valve has one of its inlets communicating with one of said target chambers, and has another of its inlets communicating with a source of a first fluid for flushing a first irradiated ion from its associated cartridge.

27. The apparatus as set forth in claim 26 wherein said first valve has another of its inlets communicating with another of said target chambers, and has another of its inlets communicating with a source of a second fluid for flushing a second irradiated ion from its associated cartridge.

28. The apparatus as set forth in claim 25 wherein said first valve has another of its inlets communicating with a recovery container.

29. The apparatus as set forth in claim 25 and further comprising:
a conduit leading from said third valve outlet;
a filter operatively arranged in said conduit; and
a collection vial communicating with said conduit.
